(19) United States
(12) Patent Application Publication
(10) Pub. No.: US 2011/0074837 A1
(43) Pub. Date: Mar. 31, 2011

(54) IMAGE DISPLAY DEVICE

(75) Inventors: Michihiro Takeda, Kiyosu-shi (JP); Hiroshi Sugimoto, Nagoya-shi (JP)

(73) Assignee: BROTHER KOGYO KABUSHIKI KAISHA, Nagoya-shi (JP)

(21) Appl. No.: 12/891,166

(22) Filed: Sep. 27, 2010

(30) Foreign Application Priority Data
Sep. 30, 2009 (JP) 2009-229110

(51) Int. Cl. G09G 5/10

(52) U.S. Cl. 345/690

(57) ABSTRACT

An image display device includes: a signal generation part which outputs an image signal corresponding to a gradation level of a pixel which constitutes an image; a laser beam source which radiates a laser beam having intensity corresponding to the image signal; and a signal adjustment part which superposes a high-frequency signal to the image signal inputted to the laser beam source. The signal adjustment part superposes a high-frequency signal which has amplitude not less than a width of a kink region where an input-output characteristic of the laser beam source changes most steeply on the image signal.

### CROSS-REFERENCE TO RELATED APPLICATIONS

This application is based on and claims the benefit of priority from Japanese Patent Application No. 2009-229110 filed on Sep. 30, 2009, the entire contents of which are incorporated herein by reference.

### BACKGROUND

1. Field

The present invention relates to an image display device, and more particularly to an image display device provided with a laser beam source which receives inputting of an image signal corresponding to a gradation level of a pixel which constitutes an image and radiates a laser beam having intensity corresponding to the image signal.

2. Description of the Related Art

Conventionally, there has been known a scanning image display device in which a laser beam whose intensity is modulated in response to an image signal is radiated from a laser beam source, the laser beam is scanned by a scanning part in two-dimensional directions, and the laser beam is projected onto a projecting object thus displaying an image. As this type of image display device, there have been known a retinal scanning display in which a retina of a user is used as the projecting object and a screen scanning image display device in which a screen is used as the projecting object, for example.

When an image displayed by the scanning image display device is a color image, it is necessary to provide a plurality of laser beam sources which generate a plurality of laser beams of different wavelengths respectively. In general, the scanning image display device uses a red laser, a green laser and a blue laser. By converging laser beams radiated from these laser beam sources on the same optical path, the laser beams are synthesized thus producing a laser beam of various colors.

### SUMMARY OF THE INVENTION

When a semiconductor laser is used as such a laser beam source, there has been known a semiconductor laser in which an input-output characteristic (current-light output characteristic) is steeply changed so that a bent portion is formed thus giving rise to a region where linearity collapses. It is desirable that the input-output characteristic smoothly continues from a first region where the increase/decrease of output intensity of light with respect to the increase/decrease of an electric current is gentle to a second region where the increase/decrease of the output intensity of the light is steep. However, there has been known a semiconductor laser in which an input-output characteristic has a third region where the increase/decrease of output intensity of light is steeper than the increase/decrease of output intensity of light of the second region between the first region and a second region. Such a third region is called a kink region. This kink region appears conspicuously with respect to a green laser and a blue laser.

In a case where the input-output characteristic of the semiconductor laser has such a kink region, when an image signal to which a gradation level is allocated on the presumption that the input-output characteristic has linearity is outputted to the semiconductor laser, a gradation crush occurs at a low gradation level.

Accordingly, when the semiconductor laser is used as a laser beam source, it is necessary to allocate an image signal at each gradation level corresponding to the above-mentioned kink region. However, this allocation processing is difficult so that the low gradation level cannot be accurately reproduced.

The present invention has been made under such circumstances, and it is an object of the present invention to provide an image display device which can easily and accurately reproduce a low gradation level even when a semiconductor laser having a kink region in an input-output characteristic thereof is used.

According to one aspect of the present invention, there is provided an image display device which includes: a signal generation part which generates and outputs an image signal corresponding to a gradation level of a pixel which constitutes an image; a laser beam source which radiates a laser beam having intensity corresponding to the image signal; and a signal adjustment part which superposes a high-frequency signal on the image signal inputted to the laser beam source. The signal adjustment part superposes a high-frequency signal which has a frequency not less than an inverse number of a generation cycle of the image signal and has amplitude not less than a width of a kink region where an input-output characteristic of the laser beam source changes most steeply on the image signal.

### BRIEF DESCRIPTION OF DRAWINGS

FIG. 1 is a block diagram showing the schematic constitution of an image display device according to one embodiment of the present invention;

FIG. 2 is a graph showing an input-output characteristic of a semiconductor laser;

FIG. 3 is a graph for explaining the input-output characteristic when a high-frequency signal is superposed on an image signal;

FIG. 4 is a graph for explaining the input-output characteristic when a high-frequency signal is superposed on an image signal;

FIG. 5 is a graph for explaining the input-output characteristic when a high-frequency signal is superposed on an image signal;

FIG. 6 is a graph for explaining the input-output characteristic when a high-frequency signal is superposed on an image signal;

FIG. 7 is a schematic view showing the electrical constitution and the optical constitution of a retinal scanning display;

FIG. 8 is a view of a scanning range in which a laser beam is scanned by a scanning part shown in FIG. 7;

FIG. 9 is a block diagram showing the constitution of a light source part shown in FIG. 7;

FIG. 10A and 10B are flowcharts showing the flow of processing executed by the retinal scanning display shown in FIG. 7;

FIG. 11 is a flowchart showing the flow of processing executed by the retinal scanning display shown in FIG. 7;

FIG. 12 is a view showing the data constitution of a gradation table;

FIG. 13 is a view showing the data constitution of a gradation table; and

FIG. 14 is a graph showing an input-output characteristic of a semiconductor laser having hysteresis.

### DESCRIPTION

Hereinafter, a mode for carrying out the present invention (hereinafter referred to as “embodiment”) is explained in conjunction with drawings.

The image display device according to this embodiment is an optical scanning type image display device. In the image display device, laser beams whose intensities are modulated in response to an image signal are radiated from laser beam sources, the laser beams are scanned by a scanning part in the two-dimensional directions, and the scanned laser beams are projected on a projecting object thus displaying a color image.

### [1. Schematic Constitution of Image Display Device 1]

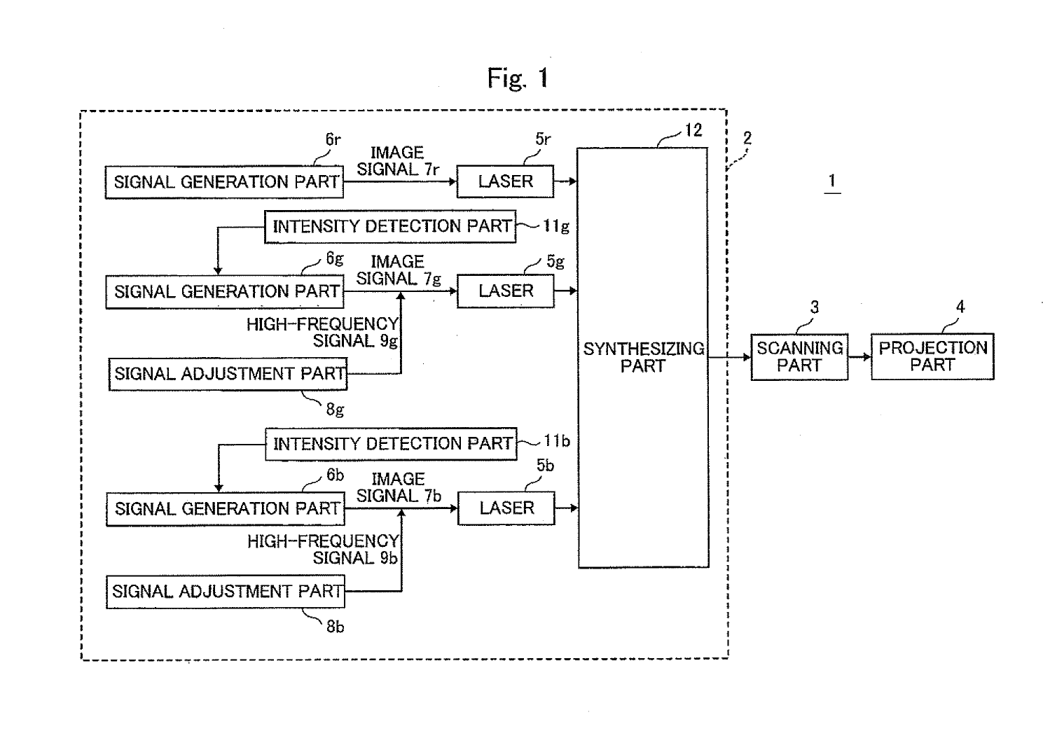

As shown in FIG. 1, the image display device 1 according to this embodiment includes a light source part 2 which sequentially radiates laser beams having intensities corresponding to respective pixels which constitute an image to be displayed, a scanning part 3 which two-dimensionally scans the laser beams radiated from the light source part 2, and a projection part 4 which projects the laser beams scanned by the scanning part 3 on the projecting object.

The light source part 2 includes, for sequentially radiating laser beams having intensities corresponding to respective pixels for three respective primary colors, a plurality of lasers 5r, 5g, 5b which radiate laser beams having different wavelengths corresponding to the respective three primary colors. The laser beams which are radiated from these laser beam sources are converged on the same optical path by a synthesizing part 12 thus synthesizing the laser beams. The laser 5r is a red semiconductor laser which radiates a red laser beam, the laser 5g is a green semiconductor laser which radiates a green laser beam, and the laser 5b is a blue semiconductor laser which radiates a blue laser beam.

Further, the light source part 2 includes signal generation part 6r, 6g, 6b which generate image signals of the above-mentioned three respective primary colors. The signal generation part 6r generates an image signal 7r having a current value (signal value) corresponding to a gradation level of the red component of each pixel, and the image signal 7r is inputted to the red laser 5r. Accordingly, the red laser beam whose intensity is modulated in response to the gradation level of the red component of each pixel is radiated from the red laser 5r.

In the same manner, the signal generation part 6g generates an image signal 7g having a current value corresponding to a gradation level of the green component of each pixel, and the image signal 7g is inputted to the green laser 5g. Further, the signal generation part 6b generates an image signal 7b having a current value corresponding to the gradation level of the blue component of each pixel, and the image signal 7b is inputted to the blue laser 5b. Accordingly, the green laser beam whose intensity is modulated in response to the gradation level of the green component of each pixel is radiated from the green laser 5g, and the blue laser beam whose intensity is modulated in response to the gradation level of the blue component of each pixel is radiated from the blue laser 5b.

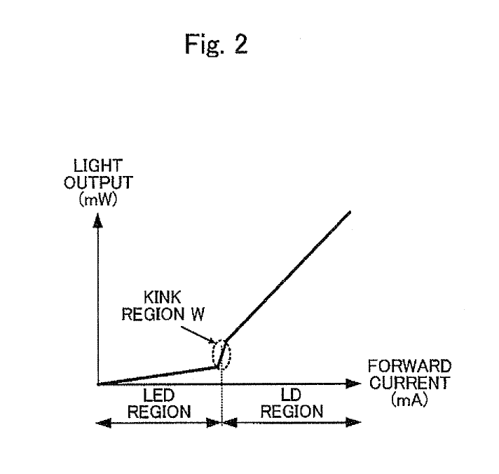

With respect to the green laser 5g and the blue laser 5b, as shown in FIG. 2, an input-output characteristic (current-light output characteristic) has a kink region W where the input-output characteristic is steeply changed so that a bent portion is formed thus collapsing linearity thereof. That is, in addition to a first region where the increase/decrease of output intensity of light with respect to the increase/decrease of an electric current is gentle and a second region where the increase/decrease of output intensity of light with respect to the increase/decrease of an electric current is steep, the input-output characteristic also has the kink region W which is a third region where the increase/decrease of output intensity of light is steeper than the increase/decrease of output intensity of light in the second region between the first region and the second region. Accordingly, with the use of the image signals 7g, 7b which are outputted from the signal generation parts 6g, 6b with current values corresponding to gradation levels, the low gradation levels cannot be accurately reproduced.

In view of the above, as shown in FIG. 1, the light source part 2 includes a signal adjustment part 8g which superposes a high-frequency signal 9g on the image signal 7g inputted to the green laser 5g, and a signal adjustment part 8b which superposes a high-frequency signal 9b on the image signal 7b inputted to the blue laser 5b. For the sake of convenience, the explanation is made hereinafter assuming that the green laser 5g and the blue laser 5b have the same input-output characteristic. However, it is not always necessary that the green laser 5g and the blue laser 5b have the same input-output characteristic, and these lasers 5g, 5b usually have different input-output characteristics. Further, either one of the lasers 5g, 5b may be expressed as “laser 5”, and either one of the signal generation parts 6g, 6b may be expressed as “signal generation part 6”. Further, either one of the image signals 7g, 7b may be expressed as “image signal 7”, either one of the signal adjustment parts 8g, 8b may be expressed as “signal adjustment part 8”, and either one of the high-frequency signals 9g, 9b may be expressed as “high-frequency signal 9”.

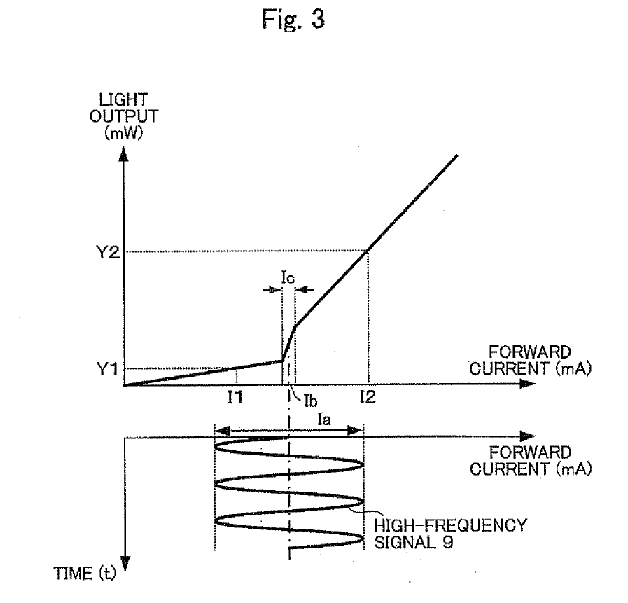

When the high-frequency signal 9 is superposed on the image signal 7 inputted to the laser 5, the intensity of the laser beam radiated from the laser 5 is changed corresponding to a change of amplitude of the high-frequency signal 9. For example, assume that the high-frequency signal 9 having current amplitude Ia is inputted to the laser 5 having the input-output characteristic shown in FIG. 2 such that the high-frequency signal 9 is superposed on the image signal 7 having a current value Ib as shown in FIG. 3. Here, a current value of an electric current inputted to the laser 5 is periodically increased or decreased between a current value I1 (=Ib−Ia/2) and a current value 12 (=Ib+Ia/2). Accordingly, intensity of light radiated from the laser 5 is also changed between an intensity value Y1 and an intensity value Y2.

In this manner, although the intensity of the laser beam radiated from the laser 5 is changed corresponding to the change of the amplitude of the high-frequency signal 9 when the high-frequency signal 9 is superposed on the image signal 7, the brightness of each pixel visually recognized by a user becomes the brightness corresponding to intensity obtained by averaging the changing intensities.

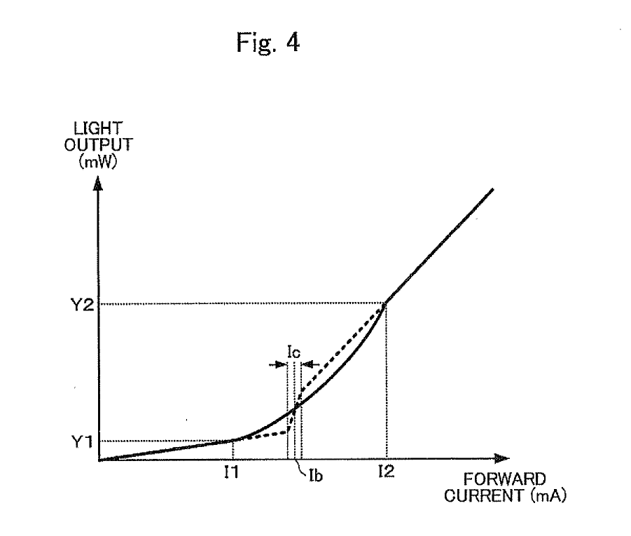

Accordingly, when the high-frequency signal 9 is superposed on the image signal 7, the input-output characteristic of the laser 5 is regarded as a characteristic which changes intensity of light corresponding to a current value of the image signal 7 as indicated by a solid line shown in FIG. 4. Hereinafter, such an input-output characteristic is referred to as an apparent input-output characteristic. A broken line shown in FIG. 4 indicates the input-output characteristic of the laser 5 when the high-frequency signal 9 is not superposed on the image signal 7.

In the image display device 1 according to this embodiment, the influence of the kink region W exerted on the input-output characteristic of the laser 5 is suppressed by superposing the high-frequency signal 9 on the image signal 7 thus approximating the relationship between the current value of the image signal 7 and the intensity of the laser beam to the proportional relationship. Due to such processing, the allocation of the current value of the image signal 7 at the low gradation level can be performed easily.

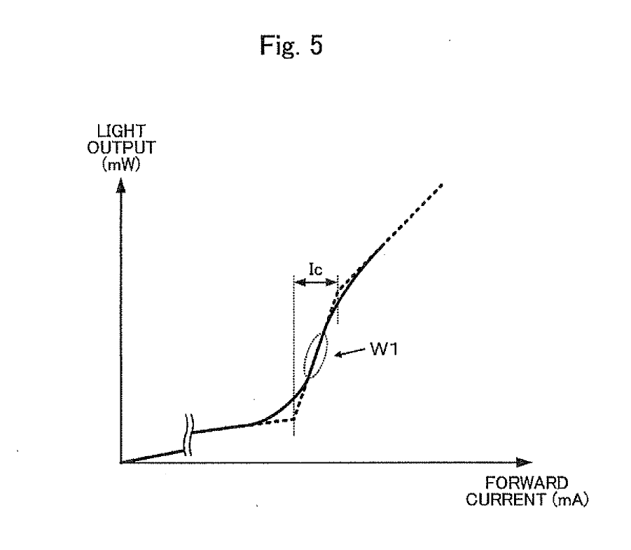

Further, in the image display device 1, it is necessary to set the current amplitude of the high-frequency signal 9 superposed on the image signal 7 to not less than a width Ic of the kink region W. That is, it is necessary that a current range of the image signal 7 where a current value is changed due to the superposition of the high-frequency signal 9 covers a range of the kink region W. It is because when the width of the high-frequency signal 9 is smaller than the width Ic of the kink region W, as shown in FIG. 5, a region W1 where the influence exerted by the kink region cannot be suppressed is generated. Further, a frequency of the high-frequency signal 9 superposed on the image signal 7 is set to a frequency which is not less than an inverse number 1/T (≧1/T) of a generation cycle T of the image signal 7 generated by the signal adjustment part 8 in accordance with every pixel. The inverse number 1/T of the generation cycle T of the image signal 7 corresponds to a frequency of a reading clock signal for reading image data from a memory not shown in the drawing.

In the image display device 1, the gradation level is allocated such that, in FIG. 4, the gradation level assumes a black level when a current value of the image signal 7 is a current value I1 and the gradation level assumes a white level when the current value of the image signal 7 is a current value I2. This is because that, as shown in FIG. 4, although the degree of increase of light intensity with respect to the increase of the current value is gently increased from the current value I1 to the current value I2, the degree of increase of the light intensity is suddenly lowered when the current value becomes equal to or more than the current value I2, and the degree of increase of the light intensity is suddenly elevated when the current value becomes the current value I1 from a current value less than the current value I1. Due to such processing, it is possible to allocate the gradation level in a region where the current value of the image signal 7 and the intensity of the laser beam exhibit the continuous degree of increase.

That is, assuming the intensity of the laser beam outputted from the laser 5 when the high-frequency signal 9 is superposed on the image signal 7 as first intensity and the intensity of the laser beam outputted from the laser 5 when the high-frequency signal 9 is not superposed on the image signal 7 as second intensity, the signal generation part 6 sets the gradation level corresponding to the lower current value I1 out of the current values I1, I2 of the image signal 7 where the first intensity and the second intensity agree with each other as a black level. On the other hand, the signal generation part 6 sets the gradation level corresponding to the higher current value I2 out of the current values I1, I2 of the image signal 7 where the first intensity and the second intensity agree with each other as a white level. Here, the black level implies, for example, the gradation level “0” at which the brightness is the lowest when the gradation of the image signal 7 is constituted of 256 gradations (gradation levels: 0 to 255), and the white level implies, for example, the gradation level “255” at which the brightness is the highest when the gradation of the image signal 7 is constituted of 256 gradations.

Further, the image display device 1 includes intensity detection parts 11g, 11b which detect intensities of laser beams radiated from the lasers 5g, 5b. The signal generation parts 6g, 6b may also perform the allocation of the gradation level corresponding to detection results obtained by the intensity detection parts 11g, 11b instead of the above-mentioned allocation of preset gradation level. For example, intensities of laser beams at a black level and a white level are preliminarily set, and current values of the image signals 7g, 7b inputted when intensities of laser beams radiated from the lasers 5g, 5b assume the preset intensities at the black level are set as current values of the image signals 7g, 7b at the black level. Further, current values of the image signals 7g, 7b inputted when intensities of laser beams radiated from the lasers 5g, 5b assume the preset intensities at the white level are set as current values of the image signals 7g, 7b at the white level. Further, image signals of the respective gradation levels are allocated corresponding to the apparent input-output characteristic between the image signals 7g, 7b at the black level and the image signals 7g, 7b at the white level.

Due to such processing, even when the input-output characteristics of the lasers 5g, 5b are changed in response to a temperature change or the lasers 5g, 5b have the individual differences, it is possible to properly allocate the gradation levels. Although laser beams whose intensities are changed due to the high-frequency signals 9g, 9b are incident on the intensity detection parts 11g, 11b, the intensity detection parts 11g, 11b are configured to output a detection signal corresponding to average intensity of the incident laser beams.

Further, the signal adjustment part 8 of the image display device 1 is configured to change amplitude of the high-frequency signal 9 corresponding to a current value of an image signal 7 which the signal generation part 6 outputs. Due to such processing, it is possible to further approximate the relationship between a current value of the image signal 7 and intensity of the laser beam to the proportional relationship.

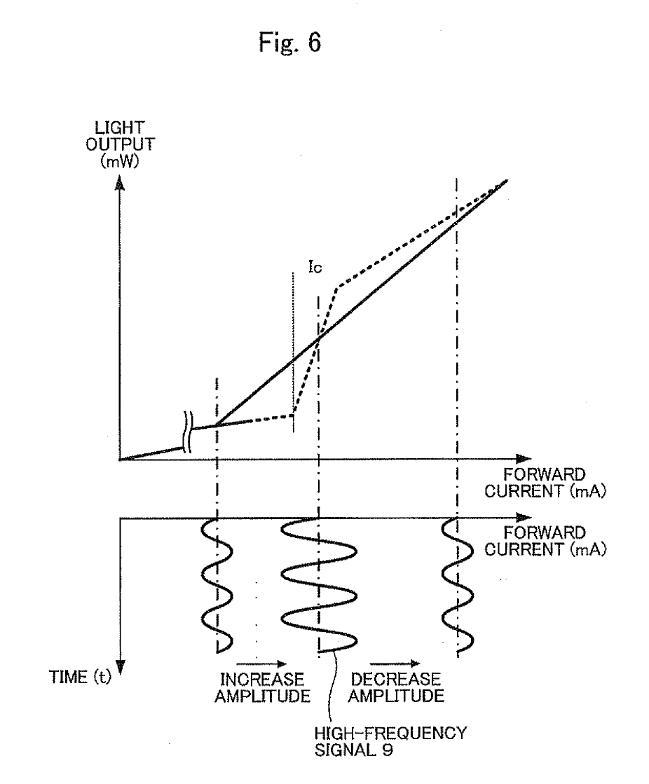

For example, with respect to the laser 5 having the input-output characteristic shown in FIG. 2, as shown in FIG. 6, the signal adjustment part 8 increases the amplitude of the high-frequency signal 9 which the signal generation part 6 outputs until a current value of an image signal 7 which the signal generation part 6 outputs reaches the center of the kink region W (predetermined value). On the other hand, when the current value of the image signal 7 which the signal generation part 6 outputs passes the center of the kink region W (second predetermined value), the signal adjustment part 8 decreases the amplitude of the high-frequency signal 9. Depending on the input-output characteristic of the laser, there may be a case where it is preferable to suitably increase or decrease the amplitude of the high-frequency signal 9 rather than increasing the amplitude of the high-frequency signal 9 until the current value of the image signal 7 assumes the predetermined value and decreasing the amplitude of the high-frequency signal 9 from the second predetermined value which is not less than the predetermined value of the image signal 7. In such a case, the signal adjustment part 8 suitably increases or decreases the amplitude of the high-frequency signal 9 which the signal generation part 6 outputs.

In this manner, in the image display device 1 according to this embodiment, the influence of the kink region W exerted on the input-output characteristic of the laser 5 can be suppressed by superposing the high-frequency signal 9 on the image signals 7 respectively thus approximating the relationship between the current value of the image signal 7 and the intensity of the laser beam to the proportional relationship. Accordingly, the allocation of the current value of the image signal 7 at the low gradation level can be performed easily. Accordingly, even when the kink region W is present in the input-output characteristic of the laser 5, it is possible to reproduce the low gradation level with high accuracy.

### [2. Application Example of Image Display Device to Retinal Scanning Display]

Hereinafter, the specific constitution and the specific manner of operation of the image display device 1 are explained hereinafter in conjunction with the case where the image display device 1 is applied to a retinal scanning display (hereinafter referred to as “RSD”).

### [2.1. Electrical Constitution and Optical Constitution of RSD 100]

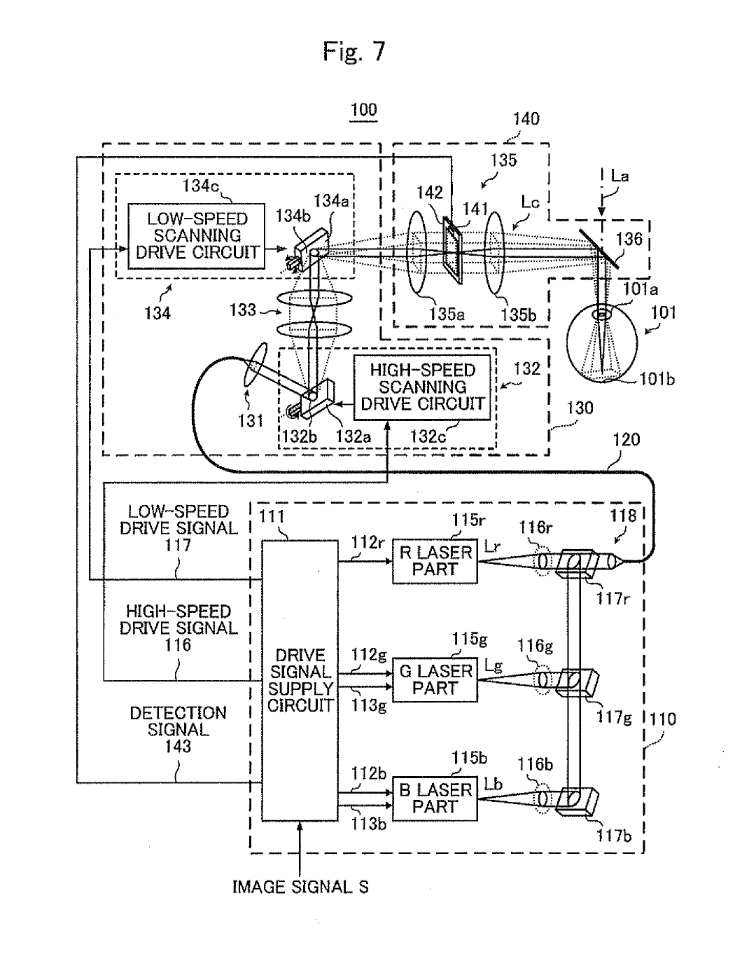

Firstly, the electrical constitution and the optical constitution of the RSD 100 are explained in conjunction with FIG. 7.

As shown in FIG. 7, the RSD 100 according to this embodiment includes a light source part 110, an optical fiber 120, a scanning part 130 and a projection part 140.

The light source part 110 includes a drive signal supply circuit 111, laser parts 115r, 115g, 115b, collimation optical systems 116r, 116g, 116b, dichroic mirrors 117r, 117g, 117b and a coupling optical system 118.

Based on the image signal S to be inputted, the drive signal supply circuit 111 generates image signals which respectively constitute elements for forming an image and correspond to respective colors of three primary colors for every pixel. That is, the drive signal supply circuit 111 generates and outputs an R (red) image signal 112r, a G (green) image signal 112g and a B (blue) image signal 112b as the image signals for respective colors. Further, the drive signal supply circuit 111 outputs a high-speed drive signal 116 which is used in the high-speed scanning part 132, and a low-speed drive signal 117 which is used in the low-speed scanning part 134 respectively. Further, the drive signal supply circuit 111 outputs control signals 113g, 113b for controlling amplitude of high-frequency signals described later which are superposed on the image signals 112g, 112b.

The R laser part 115r, the G laser part 115g and the B laser part 115b respectively radiate laser beams (also referred to as “optical flux”) whose intensities are modulated in response to an R image signal 112r, a G image signal 112g and a B image signal 112b which are respectively outputted from the drive signal supply circuit 111.

An R (red) laser beam Lr, a G (green) laser beam Lg, a B (blue) laser beam Lb radiated from the respective laser parts 115r, 115g, 115b are collimated by the collimation optical systems 116r, 116g, 116b respectively and, thereafter, the collimated laser beams are incident on the dichroic mirrors 117r, 117g, 117b respectively. Thereafter, the respective laser beams of three primary colors are reflected on or are allowed to pass through the dichroic mirrors 117r, 117g, 117b selectively corresponding to wavelengths thereof, arrive at the coupling optical system 118, and are synthesized by the coupling optical system 118. Then, the synthesized laser beams are radiated to the optical fiber 120. In this manner, the laser beams which are radiated to the optical fiber 120 constitute an image light Lc which is obtained by synthesizing the laser beams of respective colors whose intensities are modulated.

The scanning part 130 is constituted of a collimation optical system 131, the high-speed scanning part 132, a first relay optical system 133, and the low-speed scanning part 134.

The collimation optical system 131 collimates the laser beams which are generated by the light source part 110 and are radiated through the optical fiber 120.

The high-speed scanning part 132 and the low-speed scanning part 134, to bring the laser beams incident from the optical fiber 120 into a state where the laser beams can be projected onto the retina 101b of the user as an image, scan the laser beams in the main scanning direction as well as in the sub scanning direction. The high-speed scanning part 132 scans the laser beams which are incident on the high-speed scanning part 132 after being collimated by the collimation optical system 131 in the main scanning direction in a reciprocating manner for displaying an image. Further, the low-speed scanning part 134 scans the laser beams which are scanned in the main scanning direction by the high-speed scanning part 132 and are incident on the low-speed scanning part 134 by way of the first relay optical system 133 in the sub scanning direction approximately orthogonal to the main scanning direction.

The high-speed scanning part 132 includes a resonance-type deflecting element 132a having a reflection mirror 132b which scans the laser beams in the main scanning direction by swinging, and a high-speed scanning drive circuit 132c which, based on a high-speed drive signal 116, generates a drive signal for resonating the deflecting element 132a so as to swing the reflection mirror 132b of the deflecting element 132a. On the other hand, the low-speed scanning part 134 includes a non-resonance-type deflecting element 134a having a reflection mirror 134b which scans the laser beams in the sub scanning direction by swinging, and a low-speed scanning drive circuit 134c which, based on a low-speed drive signal 117, generates a drive signal for forcibly swinging the reflection mirror 134b of the deflecting element 134a in a non-resonant state. The low-speed scanning part 134 scans the laser beams for forming the image in the sub scanning direction toward a final scanning line from a first scanning line for every 1 frame of an image to be displayed. Here, “scanning line” implies one scanning in the main scanning direction performed by the high-speed scanning part 132. In this embodiment, a galvanometer mirror is used as the deflecting elements 132a, 134a. However, any one of a piezoelectric drive method, an electromagnetic drive method, an electrostatic drive method and the like may be used as a drive method of the deflecting elements 132a, 134a provided that the drive method can swing or rotate the reflection mirrors 132b, 134b for scanning the laser beams.

The first relay optical system 133 is arranged between the high-speed scanning part 132 and the low-speed scanning part 134, and relays the laser beams. The first relay optical system 133 converges the laser beams which are scanned in the main scanning direction by the reflection mirror 132b of the deflecting element 132a on the reflection mirror 134b of the deflecting element 134a. Further, the converged laser beams are scanned in the sub scanning direction by the reflection mirror 134b of the deflecting element 134a. Here, the horizontal direction of the image to be displayed is assumed as the main scanning direction and the vertical direction of the image to be displayed is assumed as the sub scanning direction. However, the vertical direction of the image to be displayed may be assumed as the main scanning direction and the horizontal direction of the image to be displayed may be assumed as the sub scanning direction.

The projection part 140 includes a second relay optical system 135 and a half mirror 136. The laser beams which are scanned by the deflecting element 134a passes through the second relay optical system 135 in which two lenses 135a, 135b having a positive refractive power are arranged in series, are reflected on the half mirror 136 positioned in front of the eye 101, and are incident on a pupil 101a of the user. Due to such an operation, the image corresponding to the image signal S is projected on the retina 101b and hence, the user recognizes the laser beams (image light Lc) which is incident on the pupil 101a as an image. The half mirror 136 also allows the external light La to pass therethrough and to be incident on the pupil 101a of the user. Accordingly, the user can visually recognize an image which is obtained by superposing the image based on the image light Lc on the scenery based on the external light La.

In the second relay optical system 135, using the lens 135a, the respective laser beams have center lines thereof arranged approximately parallel to each other, and are respectively converted into converged laser beams. Then, using the lens 135b, the converged laser beams are arranged approximately parallel to each other and, at the same time, are converted such that the center lines of these laser beams are converged on the pupil 101a of the user.

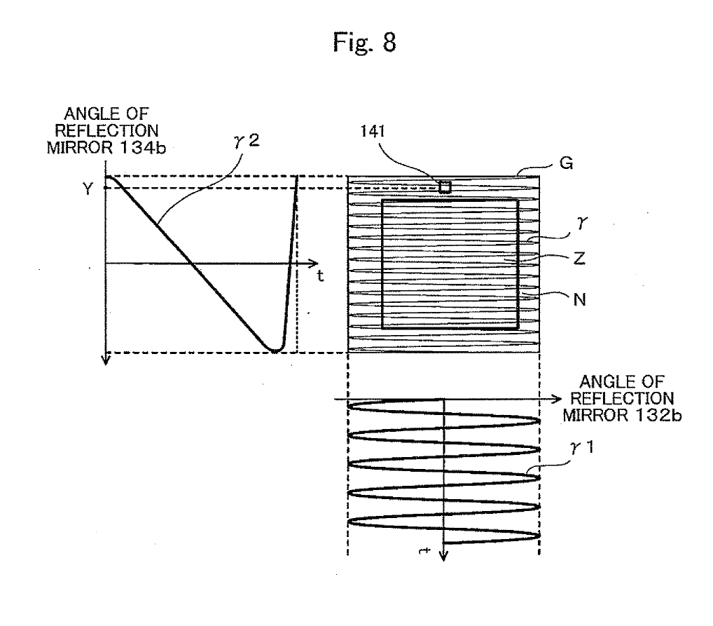

Further, the RSD 100 according to this embodiment includes a light detection part 141 for adjusting radiation timing of a laser beam radiated from the light source part 110. The light detection part 141 is constituted of a photodiode, an I-V converter and the like, and outputs a detection signal 143 when a laser beam is incident on the light detection part 141 in FIG. 8.

FIG. 8 shows the relationship between a maximum scanning range G and an effective scanning range Z obtained by the deflecting elements 132a, 134a of the high-speed scanning part 132 and the low-speed scanning part 134. Here, the “maximum scanning range G” implies a maximum range where laser beam can be scanned by the deflecting elements 132a, 134a. The image light Lc which is the laser beam whose intensity is modulated in response to an image signal S is radiated from the light source part 110 at timing where the scanning positions of the deflecting element 132a, 134a fall in the effective scanning range Z within the maximum scanning range G Due to such processing, the image light Lc is scanned within the effective scanning range Z by the deflecting element 132a, 134a, and the image light Lc for 1 frame is scanned. This scanning is repeated for every image of 1 frame. In FIG. 8, a trajectory γ of the laser beam scanned by the deflecting element 132a, 134a assuming that the laser beam is constantly radiated from the light source part 110 is virtually shown. However, the number of scanning lines in the main scanning direction in the scanning performed by the deflecting element 132a is several hundreds to several thousands for every 1 frame so that the trajectory γ of the laser beam is described in a simplified manner.

The high-speed scanning drive circuit 132c generates a drive signal by amplifying a high-speed drive signal 116, and a reflection mirror 132b of the deflecting element 132a is swung in response to the drive signal. Further, the low-speed scanning drive circuit 134c generates a drive signal by amplifying a low-speed drive signal 117, and a reflection mirror 134b of the deflecting element 134a is swung in response to the drive signal. However, swing trajectories γ1, γ2 (see FIG. 8) of the reflection mirrors 132b, 134b do not completely agree with signal waveforms of the drive signals 116, 117 thus giving rise to the generation of the phase difference or the like. Particularly, it is necessary for the deflecting element 132a to swing the reflection mirror 132b at a high speed and hence, the deflecting element 132a is a resonance-type deflecting element whereby the phase difference between the swing trajectory γ1 of the reflection mirror 132b, 134b and the signal waveform of the high-speed drive signal 116 is increased.

Accordingly, in the RSD 100 according to this embodiment, as shown in FIG. 7 and FIG. 8, a light detection part 141 for detecting scanning timing of laser beams reflected on the reflection mirrors 132b, 134b is arranged. The drive signal supply circuit 111 detects laser beams radiated from the light source part 110 by the light detection part 141, and adjusts the radiation timing of laser beams radiated from the light source part 110.

The light detection part 141 is arranged at a position where a scanned timing detection laser beam is incident in an ineffective scanning range N outside the effective scanning range Z within the maximum scanning range G. Behind the light detection part 141 in the ineffective scanning range N, a light blocking part 142 is provided for preventing a laser beam scanned outside the effective scanning range Z from being incident on an eye 101 of a user. The light blocking part 142 is formed of a non-transmissive plate-shaped member having an opening which allows a laser beam scanned in the effective scanning range Z within the maximum scanning range G to pass therethrough as shown in FIG. 7, for example. Further, the light blocking part 142 is used as a fixing member for fixing the light detection part 141. In this embodiment, an intermediate image surface is formed by a lens 135a, and the light blocking part 142 is arranged at a position of the intermediate image surface. Due to such a constitution, the light blocking part 142 can be miniaturized and, at the same time, the intermediate image surface position is a position where a beam diameter of the laser beam scanned by the scanning part 130 becomes minimum and hence, it is possible to enhance the detection accuracy of the laser beam at the light detection part 141.

### [2.1. Specific Constitution of Light Source Part 110]

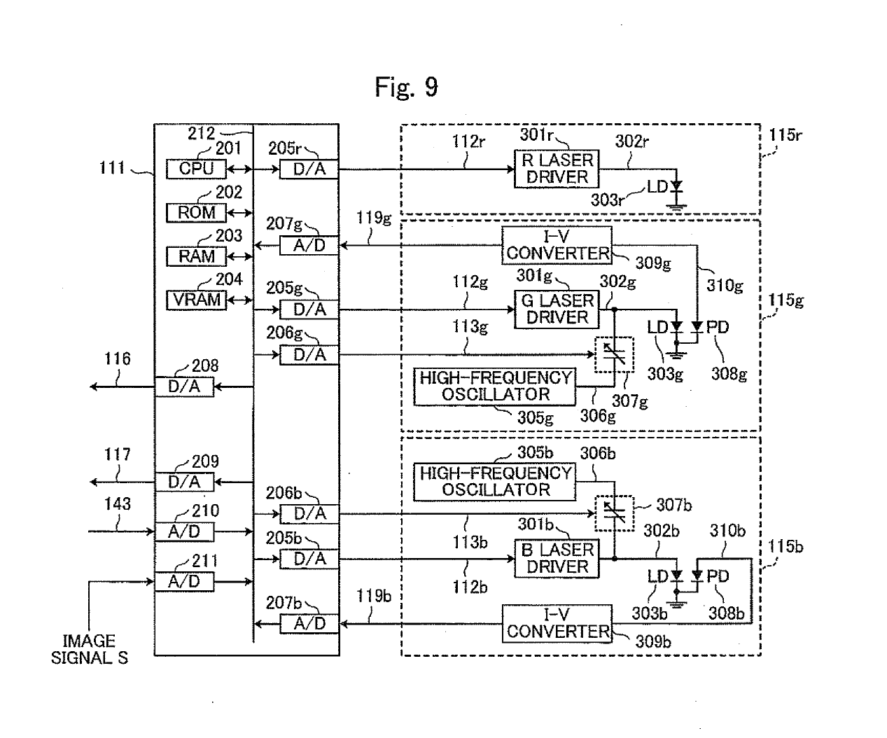

Next, the specific constitution of the light source part 110 which is a characterizing part of the RSD 100 according to this embodiment is further explained in conjunction with FIG. 9. The light source part 110 is, as described previously, constituted of the drive signal supply circuit 111, the laser parts 115r, 115g, 115b,

The drive signal supply circuit 111 includes a CPU 201, a ROM 202, a RAM 203, a VRAM 204, D/A converters 205r, 205g, 205b, 206g, 206b, 208, 209, A/D converters 207g, 207b, 210, 211 and the like. These parts are respectively connected with a data communication bus 212, and various information is transmitted and received via the bus 212. In the drive signal supply circuit 111, the CPU 201 is operated in response to execution of a control program stored in the ROM 202, and operates respective parts which constitute the RSD 100 thus executing various functions which the RSD 100 possesses. The ROM 202 stores, for example, a gradation table described later besides the above-mentioned control program. When the CPU 201 executes the control program stored in the ROM 202, the drive signal supply circuit 111 functions as a signal generation part which outputs an image signal corresponding to a gradation level of a pixel which constitutes an image and as a signal adjustment part which superposes a high-frequency signal on the image signal inputted to the laser.

The CPU 201 converts the image signal S inputted from the A/D converter 211 into image data which is constituted of a plurality of pixel data, writes the image data in the VRAM 204 and develops the image data in the VRAM 204. The VRAM 204 is used as a frame buffer. The respective pixel data stored in the VRAM 204 are constituted of R pixel data for a red component, G pixel data for a green component and B pixel data for a blue component. The CPU 201 sequentially reads the R pixel data, the G pixel data and the B pixel data developed in the VRAM 204 in accordance with every pixel, converts these pixel data into analogue data by the D/A converts 205r, 205g, 205b, and sequentially outputs the analogue data as image signals 112r, 112g, 112b.

Further, the CPU 201 convents control signals 113g, 113b for controlling amplitude of a high-frequency signal described later to be superposed on the image signals 112g, 112b into analogue signals by the D/A converters 206g, 206b and outputs the control signals 113g, 113b as the analogue signals. The drive signal supply circuit 111 includes a first mode to a third mode as operation modes thereof. Upon receiving inputting of a mode setting signal from an input I/F not shown in the drawing, based on the mode setting signal, in the drive signal supply circuit 111, a mode in which the drive signal supply circuit 111 is operated is set out of the first mode to the third mode. When the second mode is set, the CPU 201 looks up the gradation table stored in the ROM 202, and changes the amplitudes of the control signals 113g, 113b corresponding to gradation levels of the image signals 112g, 112b.

Further, the CPU 201 converts a high-speed drive signal 116 used in a high-speed scanning part 132 and a low-speed drive signal 117 used in the low-speed scanning part 134 into analog signals by the D/A converters 208, 209, and outputs these drive signals 116, 117. Further, the CPU 201 receives inputting of voltage signals 119g, 119b corresponding to electric currents which flow in photodiodes (PD) 308g, 308b described later via the A/D converters 207g, 207b. Further, the CPU 201 receives inputting of a detection signal 143 outputted from the light detection part 141 via the A/D converter 210, and detects a scanning position of the scanning part 130 based on timing at which the detection signal 143 is inputted. The CPU 201, based on the detected scanning position of the scanning part 130, determines radiation timing of a laser beam whose intensity is modulated in response to an image signal S from the light source part 110, and allows the light source part 110 to radiate the laser beam.

(R laser part 115r)

The R laser part 115r is constituted of an R laser driver 301r and an R laser diode 303r.

The R laser driver 301r generates an image signal 302r having a current value corresponding to a voltage value of the R image signal 112r outputted from the drive signal supply circuit 111, and supplies the image signal 302r to the R laser diode 303r.

A red laser beam having intensity corresponding to the image signal 302r is radiated from the R laser diode 303r. That is, the R laser diode 303r radiates the red laser beam having intensity corresponding to the R image signal 112r outputted from the drive signal supply circuit 111.

(G laser part 115g)

The G laser part 115g is constituted of a G laser driver 301g, a G laser diode 303g, a high-frequency oscillator 305g, a variable capacitor 307g, a photodiode 308g, and an I-V converter 309g.

The G laser driver 301g generates an image signal 302g having a current value corresponding to a voltage value of the G image signal 112g outputted from the drive signal supply circuit 111, and supplies the image signal 302g to the G laser diode 303g.

The high-frequency oscillator 305g generates and outputs a high-frequency signal 306g having a current value of predetermined amplitude. The frequency of the high-frequency signal 306g is a frequency of not less than an inverse number 1/Ts of a generation cycle Ts of a G image signal 112g generated by the drive signal supply circuit 111 (a cycle during which the G image signal 112g of one pixel is outputted). That is, the frequency of the high-frequency signal 306g is set to a frequency not less than a frequency of a reading clock signal for reading image data from the VRAM 204. By setting the frequency fa of the high-frequency signal 306g to the frequency of the reading clock signal or more, it is possible to reproduce the input-output characteristic of the laser whose intensity is changed as indicated by the solid line in FIG. 4 with high accuracy. However, since the reflection mirror 132b is swung due to resonance oscillation, a scanning speed is not fixed. In this case, it is also necessary to change the reading clock signal for reading the image data corresponding to the scanning speed. To reduce the influence exerted by the change of the reading clock signal, it is desirable to set the frequency of the high-frequency signal 306g higher than the frequency of the reading clock signal as much as possible. The frequency of the high-frequency signal 306g may also be referred to as a frequency which is more than two times as high as the maximum frequency within a frequency band of image signals continuously outputted from the drive signal supply circuit 111. Usually, the reading clock signal is set to the frequency which is more than two times as high as the maximum frequency.

The frequency fa of the high-frequency signal 306g may preferably be set to a frequency higher than an inverse number of a cycle for fetching a detection signal 143 by the drive signal supply circuit 111. That is, the drive signal supply circuit 111 fetches the detection signal 143 by digital conversion by operating the A/D converter 210 in response to a predetermined clock signal, and the frequency fa of the high-frequency signal 306g is set to a frequency higher than a frequency of the clock signal. Due to such frequency setting, the drive signal supply circuit 111 can reduce the erroneous detection of the detection signal 143.

The high-frequency oscillator 305g has an output end thereof connected between the G laser driver 301g and the G laser diode 303g via a variable capacitor 307g. The variable capacitor 307g is a variable capacitor which has a capacitive value corresponding to a voltage value of a G control signal 113g outputted from the drive signal supply circuit 111. When the capacitive value of the variable capacitor 307g becomes small, amplitude of the high-frequency signal 306g which is superposed on the image signal 302g becomes small, while when the capacitive value of the variable capacitor 307g becomes large, the amplitude of the high-frequency signal 306g which is superposed on the image signal 302g becomes large.

The G laser diode 303g receives inputting of an electric current which is formed by superposing the high-frequency signal 306g on the image signal 302g outputted from the G laser driver 301g, and radiates a green laser beam having intensity corresponding to the electric current. When the G laser diode 303g exhibits the input-output characteristic shown in FIG. 2, for example, by superposing the high-frequency signal 306g on the image signal 302g, the input-output characteristic of the G laser diode 303g is regarded as the characteristic in which intensity of light is changed as indicated by the solid line in FIG. 4.

The photodiode 308g is arranged at a position where the photodiode 308g receives a portion of a laser beam radiated from the G laser diode 303g, and an electric current 310g having a current value corresponding to intensity of the laser beam radiated from the G laser diode 303g flows in the photodiode 308g. The I-V converter 309g is connected to the photodiode 308g so that the voltage corresponding to the electric current 310g is outputted to the drive signal supply circuit 111 from the I-V converter 309g.

(B laser part 115g)

The B laser part 115b is constituted of a B laser driver 301b, a B laser diode 303b, a high-frequency oscillator 305b, a variable capacitor 307b, a photodiode 308b, and an I-V converter 309b.

The B laser part 115b has the substantially equal constitution as the G laser part 115g. That is, the B laser driver 301b generates an image signal 302b having a current value corresponding to a voltage value of a B image signal 112b outputted from the drive signal supply circuit 111. On the other hand, the high-frequency oscillator 305b generates and outputs a high-frequency signal 306b having a current value of predetermined amplitude. The high-frequency oscillator 305b is connected to the B laser driver 301b via the variable capacitor 307b so that the image signal 302b on which the high-frequency signal 306b is superposed is supplied to the B laser diode 303b. When the B laser diode 303b exhibits the input-output characteristic shown in FIG. 2, for example, by superposing the high-frequency signal 306b on the image signal 302b, the input-output characteristic of the B laser diode 303b is regarded as the characteristic in which the intensity of light is changed as indicated by the solid line in FIG. 4. The variable capacitor 307b is a variable capacitor having a capacitive value corresponding to a voltage value of the B control signal 113b outputted from the drive signal supply circuit 111 and, in the same manner as the G laser part 115g, amplitude of the high-frequency signal 306b which is superposed on the image signal 302b is changed corresponding to magnitude of the capacitive value of the variable capacitor 307b.

It is necessary that the frequency fb of the high-frequency signal 306b is a frequency sufficiently higher than the maximum frequency of the B image signal 112b and hence, the frequency fb of the high-frequency signal 306b is set to a frequency not less than a frequency of a reading clock signal for reading image data from the VRAM 204, for example. However, the reflection mirror 132b is swung due to resonance oscillation and hence, a scanning speed is not fixed. In this case, it is also necessary to change the reading clock signal for reading the image data corresponding to the scanning speed. To reduce the influence exerted by the change of the reading clock signal, it is desirable to set the frequency of the high-frequency signal 306b higher than the frequency of the reading clock signal as much as possible.

The photodiode 308b is arranged at a position where the photodiode 308b receives a portion of a laser beam radiated from the B laser diode 303b, and an electric current 310b having a current value corresponding to intensity of the laser beam radiated from the B laser diode 303b flows in the photodiode 308b. The I-V converter 309b is connected to the photodiode 308b so that the voltage corresponding to the electric current 310b is outputted to the drive signal supply circuit 111 from the I-V converter 309b.

### [2.2 Control Processing in RSD 100]

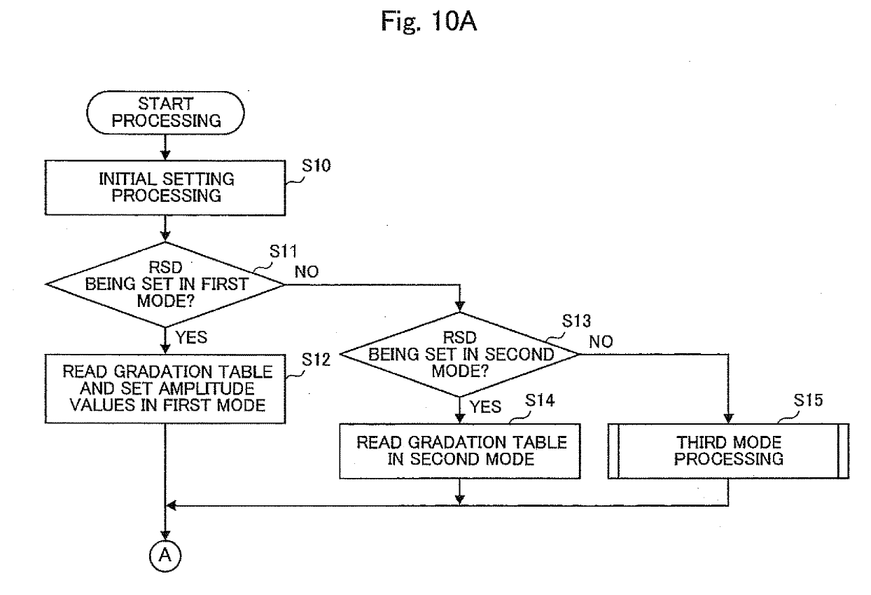

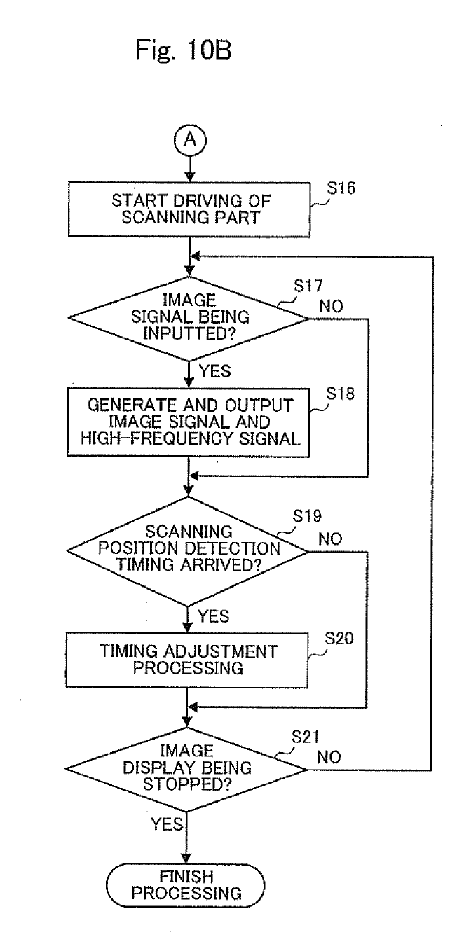

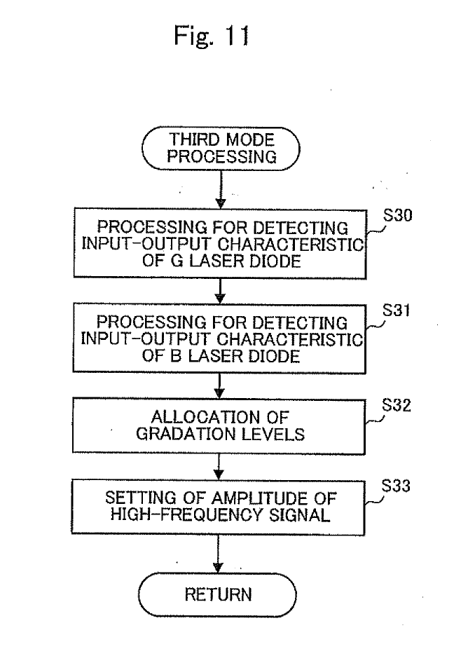

Control processing executed by the CPU 201 of the light source part 110 which constitutes the RSD 100 having the above-mentioned constitution is explained in conjunction with FIG. 10A, 10B and FIG. 11. With respect to the following processing executed by the CPU 201, the processing is started due to a power source supply operation in which a user pushes a power source button of the RSD 100 not shown in the drawing, for example.

Firstly, when the user pushes the power source button, the CPU 201 executes initial setting processing such as the initialization of a working area of the RAM 203 (step S10), and advances the processing to step S11. In the initial setting processing, the CPU 201 outputs a low-speed drive signal 117 so as to change an angle of the reflection mirror 134b (angle position Y indicated in FIG. 8) of the low-speed scanning part 134 thus allowing a laser beam reflected on the reflection mirror 134b of the low-speed scanning part 134b to be incident on the light detection part 141.

In step S11, the CPU 201 determines whether or not the RSD 100 is set in the first mode by reference to the ROM 202. Here, by inputting a mode setting signal from an input I/F not shown in the drawing thus setting a mode flag corresponding to the mode setting signal in the ROM 202, the user can set the RSD 100 in any one of the first mode to the third mode.

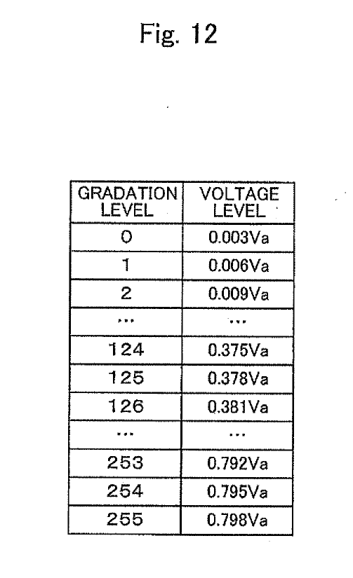

In this processing, when the CPU 201 determines that the RSD 100 is set in the first mode (step S11: YES), the CPU 201 reads a gradation table and set amplitude values of the high-frequency signal in the first mode from the ROM 202, and stores the gradation table and the set amplitude values of the high-frequency signal in the RAM 203 (step S12). The gradation table in the first mode is, as shown in FIG. 12, a table in which respective gradation levels and voltage levels of image signals 112r, 112g, 112b are associated with each other and is constituted of gradation tables for three respective primary colors.

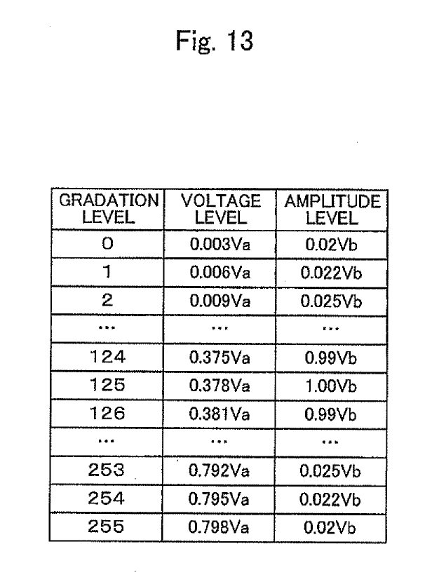

On the other hand, when the CPU 201 determines that the RSD 100 is not set in the first mode (step S11: NO), the CPU 201 determines whether or not the RSD 100 is set in the second mode (step S13). In this processing, when the CPU 201 determines that the RSD 100 is set in the second mode (step S13: YES), the CPU 201 reads a gradation table in the second mode from the ROM 202, and stores the gradation table in the RAM 203 (step S14). The gradation table in the second mode is, as shown in FIG. 13, a table in which voltage levels of the image signals 112g, 112b and voltage levels of control signals 113g, 113b for controlling amplitudes of the high-frequency signals 306g, 306b are associated with each other with respect to each gradation level, and is constituted of a gradation table for green and a gradation table for blue. On the other hand, the red gradation table is, in the same manner as the gradation table shown in FIG. 12, a table in which respective gradation levels and a voltage level of the image signal 112r are associated with each other.

On the other hand, when the CPU 201 determines that the RSD 100 is not set in the second mode (step S13: NO), the CPU 201 executes third mode processing (step S15). The processing in step S15 is constituted of processing in steps S30 to S33 shown in FIG. 11 and is described later in detail.

When the processing in steps S12, S14, S15 is finished, the CPU 201 starts driving of the scanning part 130 (step S16), In this processing, the CPU 201 outputs a sinusoidal high-speed drive signal 116 while maintaining the angle of the reflection mirror 134b set in step S10 thus starting swinging of the reflection mirror 132b. Next, the CPU 201 outputs the G image signal 112g having a predetermined voltage value thus allowing the G laser diode 303g to radiate a laser beam having predetermined intensity as a timing detection laser beam. The reflection mirror 132b scans the timing detection laser beam. Here, the timing detection laser beam scanned by the reflection mirror 132b passes through the light detection part 141 and is incident on the light detection part 141. The light detection part 141 outputs a detection signal 143 at timing that the timing detection laser beam is incident on the light detection part 141. The CPU 201 detects a scanning position in the main scanning direction determined by the deflecting element 132a based on the detection signal 143. Next, the CPU 201 stops outputting of the G image signal 112g, stops the radiation of the timing detection laser beam, and outputs a saw-tooth low-speed drive signal 117 thus starting swinging of the reflection mirror 134b. When the angle of the reflection mirror 134b of the low-speed scanning part 134 falls within the ineffective scanning range N, even when the laser beam is radiated from the light source part 110, the laser beam outputted from the scanning part 130 is blocked by the light blocking part 142 so that the laser beam is not incident on an eye 101 of the user.

Next, the CPU 201 determines whether or not the image signal S is inputted to the CPU 201 from the outside (step S17). In this processing, the CPU 201 determines that the image signal S is inputted to the CPU 201 from the outside when inputting of the image signal S from the outside is started or when inputting of the image signal S from the outside is being continued. When the CPU 201 determines that the image signal S is inputted to the CPU 201 from the outside (step S17: YES), the CPU 201 generates and outputs the image signal and the high-frequency signal (step S18).

In such processing in step S18, the CPU 201 stores the inputted image signal S in the VRAM 204 in a developed form in accordance with every pixel, and outputs the R image signal 112r, the G image signal 112g, 13 image signal 112b in accordance with every pixel. Here, the CPU 201 outputs the image signals 112r, 112g, 112b based on gradation tables for respective colors stored in the RAM 203, Further, the CPU 201 outputs control signals 113g, 113b based on set values of the high-frequency signals or the gradation tables stored in the RAM 203. Due to such processing, high-frequency currents having amplitudes corresponding to amplitude setting are superposed on the image signal 302g and the image signal 302b.

In the first mode, the fixed high-frequency signals 306g, 306b are superposed on the image signals 302g, 302b. Accordingly, there is no possibility that the high-frequency signals 306g, 306b are changed in accordance with every pixel and hence, it is possible to prevent the processing from being complicated thus reducing a load imposed on the drive signal supply circuit 111. Here, with respect to the current values of the image signals 302g, 302b where intensities of the laser beams outputted from the laser diodes 303g, 303b when the high-frequency signals 306g, 306b are superposed on the image signals 302g, 302b and intensities of the laser beams outputted from the laser diodes 303g, 303b when the high-frequency signals 306g, 306b are not superposed on the image signals 302g, 302b agree with each other, the gradation level corresponding to a higher current value out of the current values of the image signals 302g, 302b is allocated to a white level, and the gradation level corresponding to a lower current value out of the current values of the image signals 302g, 302b is allocated to the black level. Further, the gradation levels between the white level and the black level are allocated corresponding to the current values of the image signals 302g, 302b. Due to such processing, it is possible to allocate the gradation levels to a region where the current value of the image signal and the intensity of the laser beam exhibit the continuous degree of increase.

Further, in the second mode, the voltage values of the control signals 113g, 113b are set in accordance with every gradation level based on the gradation table. In this manner, by changing the amplitudes of the high-frequency signals corresponding to the current values of the image signals 302g, 302b, it is possible to further approximate the relationship between the current values of the image signals 302g, 302b and the intensity of laser beams to the proportional relationship. Accordingly, even the laser which has the kink region in the input-output characteristic thereof can easily reproduce the low gradation level with high accuracy.

Further, in the third mode, as described later, based on the detected input-output characteristics of the respective laser diodes 303g, 303b, within the preset intensity ranges, voltage values of the respective image signals 112g, 112b are set for respective gradation levels and, at the same time, voltage values of the control signals 113g, 113b are set for every gradation levels. By setting the voltage values in this manner, the amplitudes of the high-frequency signals are changed corresponding to the current values of the image signals 302g, 302b thus further approximating the relationship between the current values of the image signals 302g, 302b and intensities of the laser beams to the proportional relationship. Accordingly, even the laser having the kink region in the input-output characteristic can easily reproduce the low gradation level with high accuracy. Further, even when the individual difference or a temperature change is recognized between the respective laser diodes 303g, 303b, it is possible to reproduce the low gradation level with high accuracy.

In the processing in step S17, when the CPU 201 determines that the image signal S is not inputted from the outside (step S17: NO) and the processing in step S18 finishes, the CPU 201 determines whether or not the scanning position detection timing arrives (step S19). In this processing, the CPU 201 determines that the scanning position detection timing arrives when the angle of the reflection mirror 134b assumes an angle corresponding to a position of the light detection part 141 or another position immediately before such a position in the sub scanning direction. That is, the CPU 201 determines that the scanning position detection timing arrives when the timing detection laser beam radiated from the light source part 110 reaches a position in the sub scanning direction at which the timing detection laser beam passes through the light detection part 141 (an angular position Y shown in FIG. 8) or another position immediately before such a position.

In the processing in step S19, when the CPU 201 detatuines that the scanning position detection timing arrives (step S19: YES), the CPU 201 executes timing adjustment processing (step S20). In this timing adjustment processing, firstly, the CPU 201 outputs the G image signal 112g having a predetermined voltage value thus allowing the G laser diode 303g to radiate a laser beam having a predetermined intensity for a predetermined period as a timing detection laser beam. Here, the timing detection laser beam scanned by the deflecting element 132a passes through the light detection part 141 and is incident on the light detection part 141. The light detection part 141 outputs a detection signal 143 at timing that the timing detection laser beam is incident on the light detection part 141. The CPU 201, based on the detection signal 143, detects a scanning position in the main scanning direction brought about by the deflecting element 132a and a scanning position in the sub scanning direction brought about by the deflecting element 134a, and adjusts timing at which the laser beam whose intensity is modulated in response to the image signal S is radiated. That is, the laser beam whose intensity is modulated in response to the image signal S within the effective scanning range Z is radiated from the light source part 110.

Next, the CPU 201 determines whether or not an image display is stopped due to pushing of the power source button or an image stop button not shown in the drawing (step S21), When the CPU 201 determines that the image display is not stopped (step S21: NO), the CPU 201 returns the processing to step S17. On the other hand, when the CPU 201 determines that the image display is stopped (step S21: YES), the CPU 201 finishes the processing.

Next, the third mode processing executed in step S15 is explained in conjunction with FIG. 11.

When the third mode processing is started, the CPU 201 executes processing for detecting the input-output characteristic of the G laser diode 303g (step S30). In this processing, the CPU 201 outputs the G image signal 112g while sequentially increasing a voltage level of the G image signal 112g, while sequentially acquiring a voltage signal 119g outputted from the I/V converter 309g via the A/D converter 207g. Due to such processing, the CPU 201 acquires the input-output characteristic of the G laser diode 303g.

Next, the CPU 201 executes processing for detecting the input-output characteristic of the B laser diode 303b (step S31). In this processing, the CPU 201 outputs the B image signal 112b while sequentially increasing a voltage level of the B image signal 112b, while sequentially acquires a voltage signal 119b outputted from the I/V converter 309b via the A/D converter 207b. Due to such processing, the CPU 201 acquires the input-output characteristic of the B laser diode 303b.

Next, the CPU 201 executes the allocation of the gradation level (step S32). In this processing, the CPU 201 sets the apparent input-output characteristic based on the input-output characteristic of the G laser diode 303g detected in step S30, and decides voltage values of the G image signal 112g for respective gradation levels ranging from the black level to the white level of the gradation level based on the apparent input-output characteristic. Here, the CPU 201 determines a current value to be supplied to the G laser diode 303g when the intensity of the laser beam radiated from the G laser diode 303g assumes the lowest intensity preset in the ROM 202. The CPU 201 allocates the image signal 302g having the current value determined in this manner as the image signal of black level. Further, the CPU 201 determines a current value to be supplied to the G laser diode 303g when the intensity of the laser beam radiated from the G laser diode 303g assumes the highest intensity preset in the ROM 202, The CPU 201 allocates the image signal 302g having the current value determined in this manner as the image signal of white level. Thereafter, the CPU 201 allocates the respective gradation levels between the black level and the white level to the voltage levels of the G image signal 112g. For example, assume a case where the apparent input-output characteristic is a linear characteristic, the voltage level of the image signal corresponding to the black level is V1, the voltage level of the image signal corresponding to the white level is V2, and the number of gradations is 256. In this case, the CPU 201 allocates the voltage levels of each pixel signal to the respective gradation levels such that the voltage level of the image signal corresponding to the gradation level n(1≦n≦254) becomes n×(V2−V1)/255.

Further, in step S32, the CPU 201, in the same manner as the allocation of the gradation level with respect to the G image signal 112g, executes the allocation of the gradation level with respect to the B image signal 112b. That is, the CPU 201 sets the apparent input-output characteristic based on the input-output characteristic of the B laser diode 303b detected in step S31, and decides voltage values of the B image signal 112b for respective gradation levels ranging from the black level to the white level of the gradation level based on the apparent input-output characteristic. The specific allocation is executed in the same manner as the allocation of the gradation levels with respect to the G image signal 112g.

Next, the CPU 201 executes setting of amplitude of the high-frequency signal (step S33), and finishes the third mode processing. In the processing in step S33, the CPU 201 sets the apparent input-output characteristic based on the input-output characteristic in the G laser diode 303g detected in step S30, and sets the amplitude of the high-frequency signal such that the apparent input-output characteristic is acquired. For example, when the input-output characteristic of the G laser diode 303g assumes the characteristic indicated by a broken line in FIG. 6, the amplitude of the high-frequency signal is allocated to respective gradation levels such that the apparent input-output characteristic assumes the characteristic indicated by a solid line in FIG. 6. In the same manner, the CPU 201, based on the input-output characteristic of the B laser diode 303b detected in step S31, sets the apparent input-output characteristic, and sets the amplitude of the high-frequency signal such that the apparent input-output characteristic is acquired.

As has been explained heretofore, according to the RSD 100 of this embodiment, by superposing the high-frequency signals to the respective image signals, the influence of the kink region W exerted on the input-output characteristic of the laser can be suppressed thus approximating the relationship between the current value of the image signal and the intensity of the laser beam to the proportional relationship. Due to such processing, the allocation of the current value of the image signal at the low gradation level can be performed easily. Accordingly, it is possible to reproduce the low gradation level with high accuracy even when the kink region W is present in the input-output characteristic of the laser.

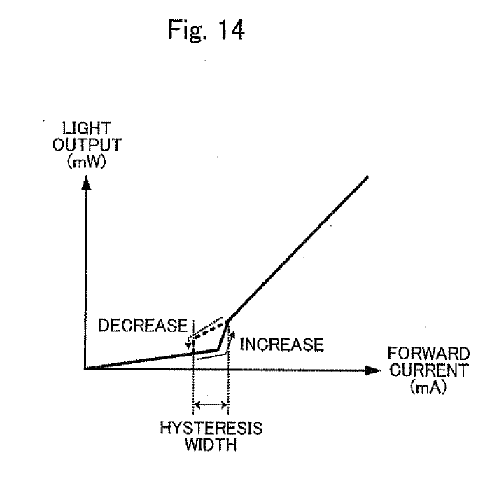

In the above-mentioned embodiment, the explanation has been made with respect to the laser which has no hysteresis in the input-output characteristic thereof. However, in a laser shown in FIG. 14 which has hysteresis in the input-output characteristic thereof, a high-frequency oscillator sets amplitude of a high-frequency signal to a value not less than a width of hysteresis. By adopting such a high-frequency oscillator, even when a laser which has hysteresis in the input-output characteristic thereof is used, the influence of the kink region W exerted on the input-output characteristic of the laser can be suppressed thus approximating the relationship between the current value of the image signal and the intensity of the laser beam to the proportional relationship. Here, the hysteresis implies a characteristic in which the kink region W changes between an input-output characteristic of a laser when an electric current supplied to the laser is decreased and the input-output characteristic of the laser when the electric current supplied to the laser is increased. The hysteresis width implies a shift of the kink region W when an electric current supplied to a laser is decreased and when an electric current supplied to a laser is increased.

What is claimed is:

1. An image display device comprising:
a signal generation part which is configured to generate and output an image signal corresponding to a gradation level of a pixel which constitutes an image;
a laser beam source which is configured to radiate a laser beam having intensity corresponding to the image signal; and
a signal adjustment part which is configured to superpose a high-frequency signal to the image signal inputted to the laser beam source, wherein
the signal adjustment part is configured to superpose a high-frequency signal which has a frequency not less than an inverse number of a generation cycle of the image signal and has amplitude not less than a width of a kink region where an input-output characteristic of the laser beam source changes most steeply on the image signal.

2. The image display device according to claim 1, wherein the signal generation part sets the gradation level corresponding to a higher signal value out of signal values of the image signal where intensity of the laser beam outputted from the laser beam source when the high-frequency signal is superposed on the image signal and the intensity of the laser beam outputted from the laser beam source when the high-frequency signal is not superposed on the image signal agree with each other as a white level.

3. The image display device according to claim 1, wherein the signal generation part sets the gradation level corresponding to a lower signal value out of signal values of the image signal where intensity of the laser beam outputted from the laser beam source when the high-frequency signal is superposed on the image signal and the intensity of the laser beam outputted from the laser beam source when the high-frequency signal is not superposed on the image signal agree with each other as a black level.

4. The image display device according to claim I, further comprising: an intensity detection part which is configured to detect the intensity of the laser beam radiated from the laser beam source, wherein
the signal generation part is configured to decide the signal value of the image signal corresponding to the black level corresponding to intensity of the laser beam detected by the intensity detection part.

5. The image display device according to claim 1, further comprising:
a scanning part which is configured to scan the laser beam radiated from the laser beam source in the two-dimensional directions; and
a light detection part which is arranged at a position where the laser beam scanned by the scanning part is incident and is configured to output a detection signal when the laser beam is incident on the light detection part, wherein
the signal generation part is configured to detect the detection signal outputted by the light detection part based on a predetermined clock signal, and is configured to adjust output timing of the image signal in response to timing at which the detection signal is detected, and
the signal adjustment part is configured to set a frequency of the high-frequency signal higher than a frequency of the predetermined clock signal.

6. The image display device according to claim 1, wherein the laser beam source has an input-output characteristic with hysteresis which exhibits different kink regions between when the signal value of the image signal is increased and when the signal value of the image signal is decreased, and
amplitude of the high-frequency signal is set larger than a hysteresis width of the laser.

7. The image display device according to claim 1, wherein the signal adjustment part is configured to change amplitude of the high-frequency signal corresponding to a signal value of the image signal which the signal generation part outputs.

8. The image display device according to claim 7, wherein the signal adjustment part is configured to increase the amplitude of the high-frequency signal corresponding to the increase of the signal value of the image signal which the signal generation part outputs until the signal value reaches at least a predetermined value,

9. The image display device according to claim 8, wherein the signal adjustment part is configured to decrease the amplitude of the high-frequency signal corresponding to the increase of the signal value of the image signal which the signal generation part outputs from a second predetermined value which is not less than the predetermined value.
